(19) United States
(12) Patent Application Publication
(10) Pub. No.: US 2002/0028167 A1
(43) Pub. Date: Mar. 7, 2002

(54) Compact purifier and method for purifying silane

(75) Inventor: William C. Breneman, Moses Lake, WA (US)

Correspondence Address: KLARQUIST SPARKMAN, LLP, One World Trade Center, Suite 1600, 121 S.W. Salmon Street, Portland, OR, 97204, US

(73) Assignee: Advanced Silicon Materials LLC

(21) Appl. No.: 09/923,590

(22) Filed: Aug. 6, 2001

Related U.S. Application Data
(63) Continuation of application No. 09/333,767, filed on Jun. 15, 1999, now abandoned.

(51) Int. Cl. B01D 53/02

(52) U.S. Cl. 423/210; 423/347; 95/116

(57) ABSTRACT

Phosphine, stilbene, and arsine are removed from silane to ultra-trace levels by passing raw silane gas through a bed of a transition element modified potassium zeolite adsorbent at a temperature above the critical temperature of silane and at a pressure of at least about 150 psi. This purification system can be incorporated into existing silane production plants to augment bulk purification methods. The system also can be located at a site where silane is to be used, to assure that delivered silane gas remains of superior quality.

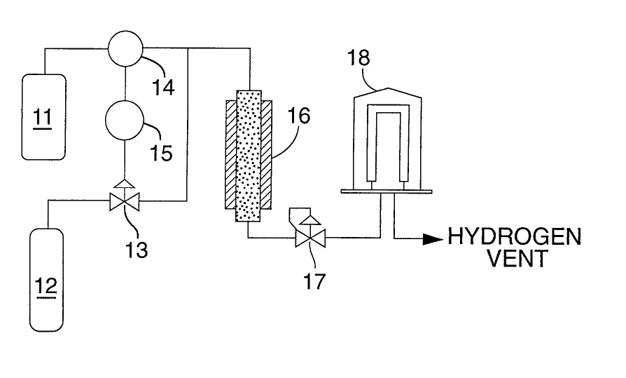

### BACKGROUND OF THE INVENTION

The present invention relates to the purification of a stream or volume of gas and in particular to the use of specialty zeolites for the removal of phosphine, stilbene, and arsine from silane gas.

Silane is an important gas for the preparation of silicon used in electronic applications. The purity of the silicon, especially for the most critical electronic applications is of supreme importance for providing the proper electrical properties in the products formed from that silicon. Certain impurities, namely boron, phosphorus and arsenic are especially harmful to the end-product use as they cannot be removed from the silicon by bulk processing methods commonly used in the semiconductor industry. The presence of these impurities at levels in the low parts per trillion (ppt) range are deleterious to the performance of the silicon-based devices. Since impurities in the silane precursor are captured into the silicon product, the purity of the silane precursor is also critical. Furthermore, as the performance of electronic devices has improved, the demand has increased for silicon material to have even lower levels of electronically active impurities. Thus there exists a need for processes to provide silane of such purity that it contains as few as twenty atoms of phosphorous, arsine or boron per trillion atoms of silicon.

A common way to purify silane is by fractional distillation as the major impurities have boiling points modestly higher than silane, except for methane, a source of carbon. Even so, it has been demonstrated that, by using two distillation units in series, adequate quality high-purity silane can be prepared by distillation to meet existing purity requirements.

The concentration of phosphine after such a distillation operation is usually less than 50 parts per trillion. However, distillation is a dynamic process in that it requires constant source of heating and cooling to effect the separation, and should one or the other of these sources be interrupted, even momentarily, the impurities will migrate against the gradient which is being forced to exist within the distillation apparatus by the application of the heat and cool sources. This disruption of the gradient results in a rather sudden and massive change in the purity of the silane product such that it is unlikely that electromechanical control systems can sense and respond quickly enough to prevent contamination of the silane product. Impurity excursions reaching as high or higher than 600 atoms per trillion atoms occur due to process disturbances. Even relatively minor disturbances can propagate impurities such that the average quality of the silane product is significantly poorer than that which is theoretically possible. Furthermore, once such contamination occurs, largely because of the extremely small amounts of impurities involved, a long period of time is required to flush the impurities from the system and return the silane quality to the low contamination levels required. In addition to the classical dilution methods, at ultra-low concentrations of impurities, diffusion and surface adsorption effects can effectively extend the period of time required to return the silane quality to its normally low impurity level.

There would be a clear advantage to the use of a passive purification method that is not subject to or effected by perturbations in feed stream rate, stream concentration or processing conditions.

Zeolites are crystalline, hydrated aluminosilicates of alkali and alkaline earth cations having infinite three-dimensional structures on an atomistic level. They are widely used in gas purification due to their unique structure, which provides internal passages of controllable size on a molecular level. The cations of the zeolites may be exchanged for other cations by well-known methods. The replacement of these exchangeable cations allows the size or window of the internal passages to be adjusted to pass smaller molecules and reject larger ones. Further, the exchangeable cations can be selected to chemically react with certain gases to further enhance the separation of one species from another.

A special class of zeolites known as molecular sieves are synthetically produced under conditions where the properties, composition and form are more closely controlled than in the natural zeolites. The use of copper or zinc modified zeolites to purify raw silane by selective adsorption of phosphine, arsine, diborane and water has been described in U.S. Pat. Nos. 3,982,912 and 4,976,944. Those patents discuss the dynamic capability of modified zeolites for the purification of gaseous silane. The former, however, suggested that operation of the adsorbent bed at reduced temperatures of about −30° C. was indicated to increase the selectivity of the modified zeolite for the impurity species over the adsorption of silane.

In U.S. Pat. No. 4,554,141 ethylene is reported to be selectively removed from silane, but the operation is again suggested at lower temperatures because of a competing reaction of silane with the aluminosilicate structure of the zeolite at temperatures above 30° C. In an extension of this technology, U.S. Pat. No. 5,211,931 describes the adsorption of ethylene from silane using a 4A molecular sieve zeolite in the temperature range of −92° F. to 75° F. and at pressures correspondingly from 100 psig to 565 psig.

### SUMMARY OF THE INVENTION

The present invention relates to a method of producing ultra pure silane, particularly silane whose phosphine concentration is less than twenty phosphorous atoms per trillion silicon atoms. In particular the present invention provides a way by which minor deviations in silane manufacturing operations are masked and overall silane quality is improved on a consistent and long-term basis.

By the method of the present invention, phosphine as well as stilbene and arsine consistently are removed to levels where less than twenty atoms each of phosphorous and arsenic are present per trillion atoms of silicon. This is best accomplished by flowing bulk distilled silane, which is normally close to its dew point, through a packed bed of a species-selective modified molecular sieve material at such a temperature, above −3.5° C. and not greater than about 40° C., and such a pressure as to prevent capillary condensation of the bulk silane, and thus achieve a consistently high rate of mass transfer and chemisorption of the impurities, and without imparting physical damage to the adsorbent.

Operating in this manner, it is possible to process silane continuously with a residence time of less than sixty seconds in a bed of molecular sieve material. And even when a high flow rate is maintained, the bed can be of relatively small volume.

### BRIEF DESCRIPTION OF THE DRAWING

The drawing is a schematic diagram of an example of a system for purifying silane according to the present invention.

### DETAILED DESCRIPTION

A system for the purification of bulk silane is illustrated schematically in the drawing. Silane from a bulk source 11 is passed through a contactor 16 holding a bed of metal-modified molecular sieve material. The zeolite is contained in a contact bed provided with outlet filters that prevent any migration of tiny zeolite particles from the bed. Heating and/or cooling apparatus (not shown) is provided to maintain the temperature of the bed within a desired range. And a back pressure regulator 17 is set to maintain the gas pressure in the contactor at a desired level.

The silane purification unit 16 is best located in one of two places. A unit can be located to receive raw silane gas from an adjacent distillation unit (not shown) that produces silane gas, e.g. at a plant site where high purity bulk silane is produced. Alternatively or in addition, a purification unit 16 can be located at the point of use of silane gas, such as at a location shortly upstream of a polysilicon deposition reactor 18 wherein silicon is deposited onto heated high purity silicon filaments to grow rods of high purity polycrystalline silicon.

The sorption mass in the contactor 16 comprises a support of a micro-porous inorganic material, such as silica, alumina, silicoaluminates or zeolites. Such a porous inorganic material has incorporated onto its surface a divalent metal oxide, in particular an oxide of a first series transition element selected from vanadium, chromium, manganese, iron, cobalt, nickel, copper, and zinc. Oxides of two or more such metals also could be used. The metal(s) can be deposited by impregnation or deposition followed by calcination to convert the metal(s) to oxide form while also removing any moisture as described in Molecular Sieves, Publication F-1979K, UOP Div. of Union Carbide Corp., 1979, incorporated herein by reference.

Preferably, the inorganic support is a molecular sieve synthetic zeolite, exchanged with copper or zinc cation. Representative zeolites are known to this art and are essentially synthetic zeolites of the A, X or Y types such as for example 3A, 4A and 5A or the 13X type. These zeolites are generally synthesized in the form of the sodium salt (4A). The sodium salt may be exchanged by different cations, and in the preferred case are exchanged with zinc cation. The degree of exchange is best from 20 to 80%.

A particularly favored zeolite, as described in U.S. Pat. No. 3,982,912 incorporated herein by reference, is a zinc-modified K-A molecular sieve wherein about 30 to 80% and about 16 to 67% of the potassium ion and zinc ion, respectively, are ion exchanged. The exchange is carried out in a conventional manner by immersing the zeolite in a solution of zinc salt with agitation and with or without heating. The exchanged zeolite is then filtered, washed, dried and finally exposed to temperature of 45020 C. under vacuum for 24 hours to complete the oxidation of the metal salt and to remove any traces of water or volatile materials. Another superior zeolite is a copper-modified K-A molecular sieve wherein about 30 to 80% and about 16 to 67% of the potassium ion and copper ion, respectively, are ion exchanged.

Although best results are achieved using synthetic molecular sieve type zeolites, natural zeolites would be operable at lower overall efficiency.

As mentioned above, the contactor unit 16 can be located to receive raw silane gas directly from an adjacent distillation unit (not shown) wherein common hydrocarbon impurities are removed to provide high purity silane gas in bulk. (For the purposes of this disclosure, “high purity silane gas” is defined as silane gas that contains no more than about 200 parts per trillion of electronically active impurities such as boron, phosphorus and arsenic.) High purity silane gas optimally is produced by distillation in such a distillation unit at operating pressures from about 19.4 bar to about 22.8 bar corresponding to a condensing point of from −34° C. to −40° C. This corresponds to the temperature where single stage mechanical refrigeration systems can operate and thus simplify manufacturing operations. When silane is passed through a distillation unit operated at these conditions a majority of certain impurities, including diborane, phosphine and arsine, are removed from the influent silane gas.

Although such operating conditions work well for distillation, operating adsorption units 16 at or near these conditions of temperature and pressure would result in unfavorable two-phase flow through the adsorption bed. Even if the total process stream were not two-phase, there would be a strong propensity for the silane to condense within the capillaries of the high surface area adsorbents. Accidentally reducing the system pressure or allowing the temperature to rise, both high probability events, would cause the liquid silane within the micro-pores of the adsorbent to expand rather rapidly and thus destroy brittle zeolite material in an adsorption unit.

The bulk or surface properties of micro-porous solid adsorbents is not a controlling factor in the rate of solute adsorption or reaction. Rather it is the rate of diffusion of the solute (phosphine) through the solvent (silane) within the micropores of the adsorbent which controls the rate of adsorption of the solute impurity.

Diffusion of the trace impurities in the silane gas to the adsorbing site within the micro-pores of the adsorbent would be inhibited by diffusional resistance through the liquid phase. In addition, transfer of the impurity across the liquid-gas interface would represent an additional resistance to mass transfer, resulting in less effective adsorption efficiency. The diffusion coefficient of a trace impurity such as phosphine, whose molecular weight and molecular size is close to that of silane, can be 3000 times faster in the silane gas phase as it would be in liquid silane.

It has now been found that the purification of bulk distilled silane best can be performed by passing the silane through a contactor 16 containing a metal-modified high surface area chemisorption solid at conditions which prevent silane from condensing within the micro-pores of the solid. Capillary condensation would severely restrict the rate of mass transfer of impurity species from the bulk silane to the active sights within molecular sieve particles. Furthermore, in the region close to, but below the critical temperature of silane, the presence of vapor and liquid phases results in capillary forces that can cause zeolites to crack as a result of internal stresses. In the single phase region above the critical pressure/temperature curve, no capillary forces occur. Cracking of the adsorbent due to capillary stress can severely reduce the long-term effectiveness of the adsorbent and contribute to the generation of small particles of the adsorbent that can migrate with the silane gas into the downstream high purity-processing environment.

To prevent silane from condensing, the silane is passed through the adsorbent at a temperature above the critical temperature of silane. The critical temperature of silane (generally accepted to be −3.5° C.) is the temperature above which silane exists in only one phase. The temperature is best maintained comfortably above the critical temperature of silane, in the range of 4° C. to 40° C.

Above its critical temperature, silane will not condense to a liquid, but remains a dense phase fluid without a surface tension or vapor-liquid interface. Operating the adsorption equipment at temperatures above the critical temperature assures a consistently high rate of diffusional mass transport and reduces the size of the adsorption unit for a given mass throughput. Furthermore, by eliminating the possibility of capillary condensation through supercritical operation, the adsorption unit can be operated at substantially elevated pressures and thereby further reduce the size of the adsorption unit for a given mass throughput. Thus the quantity of expensive metal-exchanged molecular sieve is reduced for a given process rate.

Operation at temperatures well above the critical temperature of −3.5° C. further reduces the complexity of the adsorption purification unit and reduces the possibility of accidental temperature excursions. No expensive refrigeration or heat conservation installation is required, but rather standard thermal jagging as would be used for preventing water from freezing from cold ambient temperature is all that would be required for either indoor or outdoor location of the purification unit. The risk of damage to the molecular sieve purification material due to rapid expansion of a subcritical fluid as a result of refrigeration failure is mitigated by supercritical operation. As the ultimate purpose of this purification process is to act as a fail-safe means for assuring uninterrupted flow of ultra-high purity silane, intrinsically stable operation is a key attribute of this invention.

Impure silane gas is passed through the contact bed at a pressure of at least 150 psi. Best results are achieved with operation in the range of 150-400 psi. The superficial contact time for the gas in the contact bed needs be more than 15 seconds and need not be more than 60 seconds.

Two factors determine the size of the absorption unit. First, the rate of absorption of the impurity is primarily controlled by the rate of diffusion of impurity within the adsorbent. By operating the adsorbent bed above the critical temperature of silane such that no liquid phase resistance is present, the high gaseous diffusion rates minimize the residence time the gas is required to be in contact with the adsorbent and thus minimizes the size of the adsorbent bed. Second, the ultimate capacity of the adsorbent to absorb the phosphine impurity is temperature dependent. Higher operating temperatures generally reduce the capacity of the adsorbent. Previously, it was thought that the preferred temperature of operation was about 30° C., well below the critical temperature of silane, to provide the preferred preferential adsorption of phosphine. It now has been discovered that, surprisingly, there is still a strong preference for the adsorption of phosphine at much higher temperature. This allows the metal modified molecular sieve to be used at temperatures well above −3.5° C. up to about 40° C. Reduction of the phosphine concentration in the silane from >600 parts of phosphine per trillion parts silane has been demonstrated at operational temperatures of about 35° C. while yielding purified silane having less than 20 parts of phosphine per trillion parts silane.

The measurement of phosphine concentration in silane gas has been a difficulty. The concentration of phosphine in silane gas has been inferred from analysis of silicon derived from the silane through the chemical vapor deposition (CVD) process. In the trade literature, such inference has been determined usually through epitaxial CVD. The efficiency of capture of phosphorus (using phosphine) from silane in epitaxial CVD is generally about 20%, but seems to be somewhat dependent on reactor geometry, residence time, and other process variables. Thus a silane gas containing 600 ppta phosphine would analyze by epitaxial CVD as containing only 180 ppta P.

The concentration of phosphine in raw silane, as described in this disclosure, is measured by thermally decomposing a sample of silane gas to grow a rod of polycrystalline silicon, taking a core sample from the rod, growing a single crystal of silicon from the core sample material by the float zone method, and then measuring the impurity content of the resulting silicon crystal. In this way, the initial phosphine level in the silane feed gas can be determined by a method that is not influenced by CVD conditions. The accuracy of this procedure was established by injecting a measured amount of phosphine into a substantially pure silane gas. With reactor systems wherein polycrystalline silicon rods are grown, it was possible to obtain approximately 100% capture of the phosphine. Confirmation was done by growing a large diameter polycrystalline silicon rod from the silane/phosphine gas mixture, drilling a “core” sample in the growth layer, zone crystallizing that core sample to grow a silicon crystal, and subjecting the grown crystal to cryogenic photoluminescence spectroscopy. By independent control samples, this method has an absolute detection limit of 4 parts per trillion atomic. Thus a feed gas containing 600 moles phosphine per trillion moles silane produced a silicon crystal containing 600 atoms phosphorus per trillion atoms of silicon as measured by careful quantitative analysis of the single crystal silicon, Similarly, silane gas containing 50 moles phosphine per trillion moles of silane was converted into silicon analyzed as containing 50 atoms phosphorus per trillion atoms silicon.

When a feed gas containing 600 moles phosphine per trillion moles silane was passed through a metal-modified molecular sieve in accordance with the teaching of this invention, a silicon crystal that was subsequently prepared was analyzed to contain <20 atoms phosphorous per trillion atoms of silicon. And in the most discriminating tests, the level was quantified as being at the analytical detection limit of 4 ppta.

These tests demonstrated first, that this method of determining the amount of phosphorous in the silane feed results in a 1:1 relationship between the concentration of phosphine in the gas and the phosphorous in the silicon metal and second, that a metal-modified molecular sieve, operated according to the present invention, removes the phosphine to yield silicon with extremely low levels of phosphorous.

Systems according to the present invention will be better understood with reference to the following examples.

### EXAMPLE 1

A packed bed contactor 5 cm diameter by 122 cm high is filled with a zinc modified molecular sieve of composition: 10.6% Zn, 5.7% K, 0.55% Na, 12.3% Al, 17.6% Si. The molecular sieve material was activated by heating the contactor to 450° C. under a vacuum of 1 torr for a period of 24 hours. The packed bed contactor was installed in the feed line to a polysilicon deposition reactor. As shown in the accompanying drawing, silane from a bulk source 11 was blended on-line with helium containing 544 moles phosphine per billion moles helium. The doped helium was supplied from a helium/phoshine vessel 12. The flow rate of doped helium, controlled by operation of a valve 13, was maintained in a constant ratio to the silane flow rate. The ratio was maintained constant by a ratio controller 15 that operated the valve 13 in response to changes in the silane flow rate as measured by a flow meter 14. In this way, the quantity of phosphine in the silane gas was constant at 544 atoms phosphorus per trillion atoms silicon. The precisely doped silane was then passed through the contactor 16 holding the zinc modified molecular sieve. The contactor was held at a constant temperature of 4° C. using a small refrigerator unit. A back pressure regulator 17 was used to hold the pressure in the contactor at 22 bar. Purified silane gas from the contactor 16 was fed to a polysilicon deposition reactor 18 where polycrystalline silicon was formed onto heated high purity silicon filaments. After the polycrystalline silicon filaments had grown to about 40 mm diameter, they were removed from the reactor and analyzed. Analysis was performed by cutting a short length of the silicon rod and then converting it to single crystal by float zone recrystallization. A cross sectional wafer of the mid-point of the single crystal ingot was then analyzed by cryogenic Fourier Transform Infrared spectroscopy (FTIR). The level of phosphorous was determined to be less than about 20 atoms of phosphorus per trillion atoms of silicon. The level of detection of phosphorus by this protocol has been determined to be about 15 parts per trillion (atomic).

### EXAMPLE 2

The apparatus of Example 1 was operated but with the doped silane flow bypassed around the purifier bed. In this case, the silane gas fed to the polysilicon depositon reactor contained 544 parts per billion phosphine from the on-line dopant addition as well as about 20 parts per trillion phosphine originally present in the raw silane. The analysis of the polycrystalline silicon product was determined to be 560 parts per trillion (atomic) phosphorus.

### EXAMPLE 3

The apparatus of Example 1 was operated in the same manner, except that the size of the grown polycrystalline silicon product was 80 mm diameter. A core sample was drilled across a cord of the silicon rod to provide a silicon sample containing only the freshly grown silicon from this experiment. This silicon rod was then subjected to single pass float zone recrystallization. A polished cross sectional sample from the mid-point of the single crystal sample was analyzed by cryogenic photoluminescence spectroscopy which has a limit of delectability of about 1 part per trillion for phosphorus. The analysis of the silicon produced using the purifier system showed a phosphorus level of 2 parts per trillion (atomic).

### EXAMPLE 4

The apparatus of Example 1 was operated at a temperature of 35.5° C. and a pressure of 11.2 bar with a superficial residence time of 15 seconds. The phosphorus content of the silane gas was reduced from 531 parts per trillion to 15 parts per trillion (atomic).

Having illustrated and described the principles of the invention in preferred embodiments, it should be apparent to those skilled in the art that the invention can be modified in arrangement and detail without departing from such principles. Accordingly, it is to be understood that the present invention includes all such modifications as may come within the scope and spirit of the following claims and equivalents thereof.

1. A process for the manufacture of ultrahigh purity silane comprising:
maintaining a compact contact bed of a metal-modified high surface area chemisorption solid at a temperature above the critical temperature of silane;
passing raw silane, that contains phosphine as an impurity, through the contact bed while maintaining a silane gas pressure of at least 150 psi to produce silane having a reduced concentration of phosphine; and
during the passing of the silane gas through the contact bed, maintaining the temperature and pressure at levels sufficient that the silane gas is prevented from condensing in the contact bed.

2. The process of claim 1 wherein the silane is continuously passed through a bed of the high surface area chemisorption solid with a residence time in the bed of less than sixty seconds.

3. The process of claim 1 wherein:
the high surface area chemisorption solid is a first series transition element-modified K-A molecular sieve wherein the transition element is selected from the group consisting of vanadium, chromium, manganese, iron, cobalt, nickel, copper, zinc and mixtures thereof; and
about 30 to 80% of the potassium ion and about 16 to 67% of the first series transition element ion are ion exchanged.

4. The process of claim 1 wherein:
the high surface area chemisorption solid is a copper-modified K-A molecular sieve; and
about 30 to 80% and about 16 to 67% of the potassium ion and copper ion, respectively are ion exchanged:

5. The process of claim 1 wherein:
the high surface area chemisorption solid is a zinc-modified K-A molecular sieve; and
about 30 to 80% and about 16 to 67% of the potassium ion and zinc ion, respectively are ion exchanged.

6. The process of claim 1 wherein:
the high surface area chemisorption solid is a vanadium-modified K-A molecular sieve; and
about 30 to 80% and about 16 to 67% of the potassium ion and vanadium ion, respectively are ion exchanged.

7. The process of claim 1 wherein the bed of high surface area chemisorption solid is located to receive raw silane gas from an adjacent distillation unit that produces high purity silane gas.

8. The process of claim 1 wherein the bed of high surface area chemisorption solid is located at the point of use of the silane.

9. The process of claim 1 further comprising, before passing the raw silane through the bed of high surface area chemisorption solid, passing the raw silane through at least one distillation unit at a temperature and pressure sufficient to remove a majority of impurities contained in the silane.

10. The process of claim 1 wherein the reduced concentration of phosphine is less than twenty phosphorous atoms per trillion silicon atoms.

11. The process of claim 8 wherein the reduced concentration of phosphine is less than five phosphorous atoms per trillion silicon atoms.
